(19) United States
(12) Patent Application Publication
(10) Pub. No.: US 2026/0119626 A1
(43) Pub. Date: Apr. 30, 2026

(54) SYSTEM AND METHOD FOR IMPLEMENTING THREE-PARTY IDENTITY VERIFICATION PROTOCOL BASED ON SECURE DEEP LINK

(71) Applicant: Alipay (Hangzhou) Digital Service Technology Co., Ltd., Hangzhou (CN)

(72) Inventor: Shangcheng Shi, Hangzhou (CN)

(21) Appl. No.: 19/432,762

(22) Filed: Dec. 24, 2025

Related U.S. Application Data
(63) Continuation of application No. PCT/CN2024/108524, filed on Jul. 30, 2024.

(30) Foreign Application Priority Data
Aug. 23, 2023 (CN) 202311071586.6

(51) Int. Cl. G06F 21/31

(52) U.S. Cl. CPC G06F 21/31

(57) ABSTRACT

A system for implementing a three-party identity verification protocol based on a secure deep link, includes a service requester and a service provider. The service requester sends an identity verification request; and when an application credential token is received through a secure deep link, sends an identity verification request to which the application credential token is added. The service provider receives the identity verification request; determines whether the identity verification request includes an application credential token; and if no application credential token is included, obtains, based on the first identity verification request, a secure deep link pre-registered by the service requester, and generates an application credential token based on the first identity verification request; and returns the application credential token through the secure deep link; or if a token is included, checks the application credential token; and if the check succeeds, performs identity verification; otherwise, rejects face-based identity verification.

### CROSS-REFERENCE TO RELATED APPLICATIONS

This application is a continuation application of International Application No. PCT/CN2024/108524, filed July 30, 2024, which claims priority to Chinese Patent Application No. 202311071586.6, filed on August 23, 2023, the entire contents of both of which are incorporated herein by reference.

### TECHNICAL FIELD

The present disclosure generally relates to the field of mobile security, and in particular, to a system and a method for implementing a three-party identity verification protocol based on a secure deep link.

### BACKGROUND

Currently, various large mobile applications, installed on devices referred to as service providers herein, provide various types of three-party identity verification services, including a face-based identity verification service, to external merchant applications. By using the three-party face-based identity verification service, the merchant applications serving as identity verification service requesters can verify and confirm real identities of end users of the merchant applications by using the identity verification services provided by the service providers.

The three-party identity verification service involves four entities: a service requester client, a service requester server, a service provider client, and a service provider server. In some cases, an attacker may normally generate an identity verification request through a normal service requester client (that is, a target application) on a device of the attacker, and then inject the generated identity verification request into a malicious application on a victim device controlled by the attacker, to forge the identity verification request in the malicious application into a face request of the target application, so as to induce a user to scan a face and eventually obtain a benefit of a victim in the target application (similar to a phishing attack). Therefore, for security compliance considerations, the service provider needs to actively verify an association between the service requester client and a received identity verification request, to avoid a case in which identity verification on an identity verification request forged by the malicious application succeeds.

However, in some existing devices, due to privacy policy limitations of an underlying operating system, the service provider client cannot normally obtain identity information of an external service requester client as a basis for the above security detection.

In view of the above situation, it is desired to provide a new three-party identity verification protocol based on a secure deep link mechanism that ensures validity and uniqueness of a jump target. The three-party identity verification protocol can verify the association between the service requester client and the identity verification request without depending on a system interface, thereby enhancing security of the three-party identity verification protocol.

### SUMMARY

According to a first aspect of the present disclosure, a system for implementing a three-party identity verification protocol based on a secure deep link, includes a service requester and a service provider. The service requester generates a first identity verification request; sends the first identity verification request to the service provider; when an application credential token is received through a secure deep link, adds the application credential token to the first identity verification request to obtain a second identity verification request; and sends the second identity verification request to the service provider. The service provider receives the first identity verification request sent by the service requester; determines whether the first identity verification request includes an application credential token; and if no application credential token is included, obtains a secure deep link pre-registered by the service requester, and generates an application credential token based on the first identity verification request; returns the application credential token to the service requester through the secure deep link; receives the second identity verification request sent by the service requester, and checks the application credential token carried in the second identity verification request; and if the check succeeds, performs identity verification based on the second identity verification request; otherwise, rejects identity verification.

According to a second aspect of the present disclosure, a method for implementing a three-party identity verification protocol based on a secure deep link is applied to a service provider, and includes: receiving a first identity verification request sent by a service requester, where the first identity verification request is generated by the service requester; determining whether the first identity verification request includes an application credential token; and if no application credential token is included, obtaining a secure deep link pre-registered by the service requester, and generating an application credential token based on the first identity verification request; returning the application credential token to the service requester through the secure deep link, so that the service requester adds the application credential token to the first identity verification request to obtain a second identity verification request; receiving the second identity verification request sent by the service requester; checking the application credential token carried in the second identity verification request; and if the check succeeds, performing identity verification based on the second identity verification request; otherwise, rejecting identity verification.

According to a third aspect of the present disclosure, a method for implementing a three-party identity verification protocol based on a secure deep link is applied to a service requester, and includes: generating a first identity verification request; sending the first identity verification request to a service provider, so that the service provider determines whether the first identity verification request includes an application credential token, and when no application credential token is included, obtains a secure deep link pre-registered by the service requester, and generates an application credential token based on the first identity verification request; receiving, through the secure deep link, the application credential token returned by the service provider; adding the application credential token to the first identity verification request to obtain a second identity verification request; sending the second identity verification request to the service provider, so that the service provider checks the application credential token carried in the second identity verification request; and receiving an identity verification result returned by the service provider after the check succeeds and identity verification continues to be performed based on the second identity verification request.

### BRIEF DESCRIPTION OF DRAWINGS

FIG. 1 is a schematic diagram of a method for implementing a three-party identity verification protocol based on a secure deep link, according to an embodiment.

FIG. 2 is a flowchart of a method for implementing a three-party identity verification protocol based on a secure deep link, according to an embodiment.

FIG. 3 is a flowchart of a method for implementing a three-party identity verification protocol based on a secure deep link, according to an embodiment.

FIG. 4 is a schematic diagram of a system for implementing a three-party identity verification protocol based on a secure deep link, according to an embodiment.

FIG. 5 is a schematic diagram of a computing device for implementing a three-party identity verification protocol based on a secure deep link, according to an embodiment.

### DETAILED DESCRIPTION OF EMBODIMENTS

The following further describes embodiments of the present disclosure. It should be understood that the following embodiments are merely examples, and are not intended to limit the scope of the present disclosure.

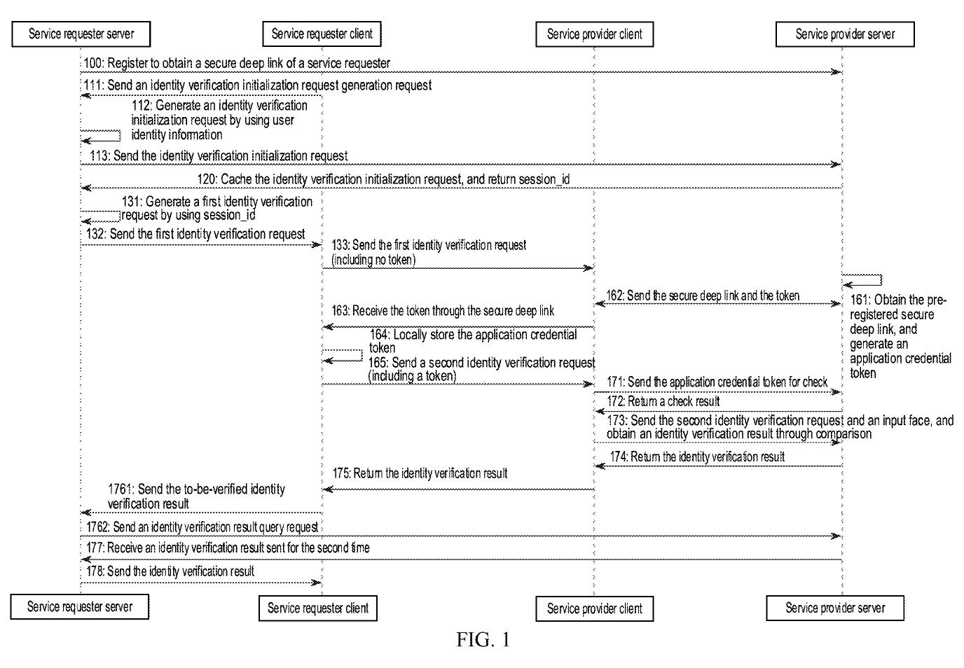

FIG. 1 is a schematic diagram of a method for implementing a three-party identity verification protocol based on a secure deep link, according to an embodiment. The method relates to a service requester and a service provider. The service requester includes at least one of a service requester client (e.g., a merchant app) on user equipment or a service requester server. The service provider includes at least one of a service provider client (e.g., a manufacturer app) on user equipment or a service provider server. The service requester client and the service provider client can be located on the same user equipment, and the user equipment can be an Android or iOS device.

As shown in FIG. 1, the method can include the following steps.

Step 100: The service requester registers to obtain a secure deep link of the service requester, and registers the secure deep link with the service provider server of the service provider.

The secure deep link is used to ensure validity and uniqueness of a jump target. When the user equipment is an Android device, the secure deep link is an app link. When the user equipment is an iOS device, the secure deep link is a universal link. In this embodiment, the used secure deep link is specifically an app link.

Step 100 can specifically include: Step 101 (not shown): The service requester server installs the service requester client on the user equipment, to register with the user equipment to obtain the secure deep link (for example, a URL) of the service requester, and sends the secure deep link of the service requester to the service provider server of the service provider. Step 102 (not shown): The service provider server generates an identifier of the service requester, to complete registration, and sends the identifier of the service requester to the service requester server.

Therefore, after registering, with the user equipment, a secure deep link used to wake up an authorized merchant, the authorized merchant registers the secure deep link of the authorized merchant with the service provider server, so that an app link registration list of a secure deep link of the service provider server includes a secure deep link used to wake up each authorized merchant and an identifier of each authorized merchant. Then, the service provider server can transfer sensitive data such as a token through the secure deep link of the service requester in the list, so that the sensitive data can be securely transferred only to the authorized merchant.

Step 110 (not shown): In response to a user identity authentication request, the service requester generates an identity verification initialization request by using to-be-authenticated user identity information in the user identity authentication request, and sends the identity verification initialization request. The user identity authentication request can be from various service requester clients. The user identity authentication request can be a request triggered when some privacy information is queried in the service requester client.

In this embodiment, the user identity information can include an identity card number, a name, etc. The identity verification initialization request is a string that includes the user identity information.

Step 110 can specifically include: Step 111: The service requester client sends an identity verification initialization request generation request to the service requester server in response to the user identity authentication request, to request to generate the identity verification initialization request. Step 112: In response to the identity verification initialization request generation request, the service requester server generates the identity verification initialization request by using the user identity information. Step 113: The service requester server sends the identity verification initialization request to the service provider server.

Step 120: The service provider server receives the identity verification initialization request, caches the identity verification initialization request in a session, and returns a session ID, session_id, related to the session to the service requester server of the service requester. The session is used by the service provider server to store the user identity information provided by the service requester. Then, session_id is returned to the service requester, and session_id is stored in a cookie of the service requester server.

Step 120 can specifically includes: Step 121 (not shown): The service provider server receives the identity verification initialization request sent by the service requester, where the identity verification initialization request is generated by the service requester by using the user identity information in response to the user identity authentication request. Step 122 (not shown): The service provider server creates a new session, and generates session_id related to the session. Step 123 (not shown): The service provider server caches the identity verification initialization request in the session, so that the cached identity verification initialization request is related to session_id and can be queried by using session_id. Step 124 (not shown): The service provider server returns session_id to the service requester server of the service requester.

Step 130 (not shown): The service requester generates and sends a first identity verification request, where the first identity verification request includes the identifier of the service requester. In this embodiment, because identity verification is performed for the first time in this case, the first identity verification request sent this time includes no application credential token.

In this embodiment, the first identity verification request is a face-based identity verification request. A first identity verification request sent each time corresponds to one piece of user identity information, and a first identity verification request sent next time corresponds to another piece of user identity information. This is applicable to a case in which a different face may need to be verified each time in the three-party identity verification protocol.

In this embodiment, the first identity verification request is generated based on session_id, and therefore corresponds to the user identity information stored in the service provider in advance.

Step 130 can specifically include: Step 131: The service requester server of the service requester generates the first identity verification request certify_url by using session_id. Because each first identity verification request is generated based on current session_id, session_id is related to the identity verification initialization request, and the identity verification initialization request corresponds to the user identity information. Therefore, each time in response to the user identity authentication request, Step 110 and Step 120 are performed again to obtain new user identity information and a new session, and then Step 131 is performed to establish an association between a current first identity verification request and current user identity information, so that the first identity verification request is related to the user identity information. In an implementation, the first identity verification request includes the user identity information. Step 132: The service requester client receives the first identity verification request sent by the service requester server. As described above, this first identity verification request includes no application credential token. Step 133: The service requester client sends the first identity verification request (including no token).

Step 140 (not shown): The service provider client receives the first identity verification request sent by the service requester client.

Step 150 (not shown): The service provider client determines whether the first identity verification request includes an application credential token. If no application credential token is included, it indicates that three-party face-based identity verification is performed for the first time in this case, and Step 160 (not shown) is performed. When the service requester client initiates the identity verification request for the first time, a handshake operation between the service requester client and the service provider client needs to be performed to obtain an application credential token, so as to obtain the application credential token.

Step 160 corresponds to a case in which there is no application credential token, that is, corresponds to a first half of a procedure in which the service requester client sends the identity verification request for the first time, is used for the handshake operation between the service requester client and the service provider client, and specifically includes Steps 161 to 165.

Step 161: The service provider server obtains, based on the first identity verification request, the secure deep link pre-registered by the service requester, and generates an application credential token based on the first identity verification request. That the service provider server obtains, based on the first identity verification request, the secure deep link pre-registered by the service requester specifically includes: The service provider server receives the first identity verification request sent by the service provider client, where the first identity verification request includes the identifier of the service requester; and the service provider server obtains, based on the identifier of the service requester, the secure deep link pre-registered by the service requester, and generates the application credential token based on the first identity verification request.

The generating an application credential token based on the first identity verification request specifically includes: generating the application credential token based on merchant identity information in the first identity verification request. The merchant identity information includes a type of the user equipment and a mobile application type of the service requester client, that is, a device+mobile application dimension. The service provider server obtains the merchant identity information based on request information in the first identity verification request, generates a group of random numbers by using a random mechanism based on the merchant identity information, and uses the group of random numbers as the application credential token.

Step 162: The service provider server sends the secure deep link and the application credential token to the service provider client.

Step 163: The service provider client returns the application credential token to the service requester client of the service requester through the secure deep link. Herein, the secure deep link mechanism can ensure validity and uniqueness of a jump target, and ensure that an application credential token generated by a manufacturer is transferred to a unique authorized service requester client. For an unauthorized service requester client, although an identity verification request generated by the unauthorized service requester client can include false merchant identity information to deceive the service provider into generating an application credential token, the unauthorized service requester client cannot receive the application credential token through a secure deep link. Therefore, the service provider client can verify a real identity of the service requester client based on a valid application credential token, and support subsequent security detection (that is, association detection between the identity verification request and the service requester client).

Step 164: The service requester client locally stores the application credential token. Therefore, the service requester stores the application credential token.

The service requester client locally stores the application credential token by using a key store system, and does not store the application credential token in a plaintext form, thereby achieving relatively high security.

In this embodiment, the user equipment is an iOS device, and a keychain is used as the key store system to locally store the application credential token. The application credential token according to the present invention can be locally stored by using a keychain capability provided by an iOS system, and is not stored in a plaintext form, thereby achieving relatively high security. In another embodiment, when the user equipment is an Android device, Keystore is used as the key store system to locally store the application credential token.

Step 165: The service requester client adds the application credential token to the first identity verification request to obtain a second identity verification request, and sends the second identity verification request to the service provider client for receiving by the service provider client.

Step 170 (not shown): Receive the second identity verification request sent by the service requester, and check the application credential token carried in the second identity verification request; and if the check succeeds, perform identity verification based on the second identity verification request; otherwise, reject identity verification.

Step 170 corresponds to a second half of the procedure for the three-party face-based identity verification performed for the first time. Step 170 can specifically include: Step 171: The service provider client sends the application credential token to the service provider server, so that the service provider server checks the application credential token. Step 172: Return a check result. Step 173: If the check succeeds, the service provider server performs identity verification based on the second identity verification request. In this embodiment, the second identity verification request is a face-based identity verification request. Therefore, that the service provider server performs identity verification based on the second identity verification request specifically includes: The service provider server receives a face that is input by a user and that is sent by the service provider client, compares the face input by the user with user identity information corresponding to the face-based identity verification request, obtains an identity verification result based on a comparison result, and returns the identity verification result to the service provider client.

That the service provider server compares the face input by the user with user identity information corresponding to the face-based identity verification request specifically includes: obtaining the corresponding user identity information based on the first identity verification request, querying a corresponding correct user face based on the user identity information, and using a comparison result between the face input by the user and the correct user face as the comparison result between the face input by the user and the user identity information corresponding to the identity verification request.

If the comparison result between the face and the identity verification request indicates a match, the identity verification result indicates a success. Otherwise, the identity verification result indicates a failure.

The identity verification request is generated based on session_id (that is, includes session_id), and the identity verification initialization request cached by the service provider server is related to session_id and can be queried by using session_id. Therefore, the obtaining user identity information corresponding to the face-based identity verification request specifically includes: The service provider server queries the cached identity verification initialization request based on session_id in the identity verification request, to obtain the user identity information in the identity verification initialization request.

In some other embodiments, the application credential token may be valid within a specified quantity of uses, and the check performed by the service provider server on the application credential token in step 171 can be implemented through redemption, so that the application credential token becomes invalid after redemption during the specified quantity of uses succeeds.

Therefore, the merchant identity information is verified.

Step 174: The service requester server returns the identity verification result to the service provider client.

Step 175: The service provider client returns the identity verification result to the service requester client of the service requester.

Step 176 (not shown): The service requester sends an identity verification result query request to the service provider server in response to the identity verification result, and receives an identity verification result returned by the service provider server. Therefore, the identity verification result is confirmed for the second time.

In this embodiment, the identity verification result merely indicates a success or a failure, and therefore needs to be confirmed for the second time, to prevent another person from forging the identity verification result. In another embodiment, Step 173 can be omitted if the identity verification result further includes anti-counterfeiting data to increase difficulty of forging the identity verification result.

Step 176 can specifically include: Step 1761: The service requester client sends the to-be-verified identity verification result to the service requester server. Step 1762: The service requester server sends the identity verification result query request to the service provider server in response to the identity verification result, so that the service provider server queries the corresponding identity verification result based on the identity verification result query request, and sends the identity verification result to the service requester server. After the performing identity verification based on the identity verification request, and before the returning the identity verification result to the service requester, the method further includes: The service provider server caches the identity verification result in a corresponding session. Correspondingly, in Step 1762, the identity verification result query request includes session_id, and the service provider server queries the corresponding session based on session_id in the identity verification result query request, to obtain the corresponding identity verification result.

Step 177: The service requester server receives an identity verification result sent by the service provider server for the second time.

Step 178: The service requester server sends the identity verification result to the service requester client. Therefore, the service requester client of the service requester grants a corresponding benefit when the received identity verification result indicates a success.

Therefore, the entire procedure for the three-party face-based identity verification performed for the first time is completed by performing the above described steps.

In the above, the service requester client has stored an application credential token. Therefore, after the three-party face-based identity verification performed for the first time is completed, the service requester client can directly read the local application credential token and initiate a request, and the service provider client can directly verify the merchant identity information by checking the application credential token. The following describes in detail a specific procedure for subsequent three-party face-based identity verification when there is an application credential token after the entire procedure for the three-party face-based identity verification performed for the first time is completed.

Step 110' (not shown): The service requester determines whether the service requester stores a valid application credential token, and if yes, generates a first identity verification request that carries the application credential token; otherwise, generates a first identity verification request that carries no application credential token. Then, the service requester client sends the first identity verification request to the service provider client. The first identity verification request that carries the application credential token can be generated in the following manner: The service requester generates and sends an identity verification initialization request in response to a user identity authentication request, where the identity verification initialization request corresponds to user identity information. The service provider server receives the identity verification initialization request, caches the identity verification initialization request in a session, and returns session_id related to the session to the service requester server of the service requester. The service requester determines whether the service requester stores a valid application credential token, and if yes, generates a first identity verification request that carries the application credential token based on session_id and the application credential token.

That is, Step 110' includes: Step 111' (not shown): The service requester server generates a first identity verification request based on session_id, where the first identity verification request includes the identifier of the service requester. Step 112' (not shown): The service requester client receives the first identity verification request sent by the service requester server. In this case, the first identity verification request includes no application credential token.

Step 113' (not shown) : Determine, at the service requester client, whether the service requester stores a valid application credential token, and if yes, read the application credential token, and generate a first identity verification request that carries the application credential token; otherwise, generate a first identity verification request that carries no application credential token.

Step 114' (not shown): The service requester client sends the first identity verification request.

Step 120' (not shown, corresponding to Step 150 described above): The service provider client determines whether the first identity verification request includes an application credential token. When the first identity verification request includes an application credential token, Step 130' is performed.

Step 130' can specifically include: Step 131' (not shown): The service provider client sends the application credential token to the service provider server, so that the service provider server checks the application credential token; and if the check succeeds, the service provider server performs identity verification based on the second identity verification request. Step 132' (not shown): The service provider client returns an identity verification result to the service requester client of the service requester. Step 133' (not shown): The service requester sends an identity verification result query request to the service provider server in response to the identity verification result, and receives an identity verification result returned by the service provider server. Therefore, the identity verification result is confirmed for the second time.

Step 134' (not shown): The service requester server receives an identity verification result sent by the service provider server for the second time. Step 135' (not shown): The service requester server sends the identity verification result to the service requester client. Therefore, the service requester client of the service requester grants a corresponding benefit when the received identity verification result indicates a success.

In the above embodiment, an application credential token is transmitted through a secure deep link, which can ensure that an application credential token generated by a manufacturer is transferred to a unique authorized service requester, and therefore a service provider can verify a real identity of the service requester based on the application credential token.

In another embodiment, the service requester is configured to: generate a first identity verification request; send the first identity verification request to the service provider; when an application credential token is received through a secure deep link, add the application credential token to the first identity verification request to obtain a second identity verification request; and send the second identity verification request to the service provider.

The service provider receives the first identity verification request sent by the service requester; determines whether the first identity verification request includes an application credential token; and if no application credential token is included, obtains a secure deep link pre-registered by the service requester, and generates an application credential token based on the first identity verification request; returns the application credential token to the service requester through the secure deep link; receives the second identity verification request sent by the service requester, and checks the application credential token carried in the second identity verification request; and if the check succeeds, performs identity verification based on the second identity verification request; otherwise, rejects identity verification.

After the application credential token is received through the secure deep link, the service requester is further configured to locally store the application credential token. Correspondingly, the service provider is further configured to: if the first identity verification request includes an application credential token, check the application credential token carried in the first identity verification request; and if the check succeeds, perform identity verification based on the first identity verification request; otherwise, reject identity verification.

In this embodiment, the service requester is specifically configured to: determine whether the service requester stores a valid application credential token, and if yes, generate a first identity verification request that carries the application credential token; otherwise, generate a first identity verification request that carries no application credential token.

In this embodiment, the secure deep link is an app link or a universal link. Correspondingly, before generating the identity verification request, the service requester is further configured to: register to obtain the secure deep link of the service requester; send the secure deep link of the service requester to the service provider; and receive an identifier that is of the service requester and that is sent by the service provider. Before receiving the identity verification request sent by the service requester, the service provider is further configured to: receive the secure deep link obtained by the service requester through registration; generate the identifier of the service requester, to complete pre-registration of the secure deep link; and send the identifier of the service requester to the service requester. The first identity verification request includes the identifier of the service requester.

In this embodiment, the service provider includes a service provider server and a service provider client. The service provider server is specifically configured to: receive the first identity verification request sent by the service provider client; obtain the secure deep link pre-registered by the service requester, and generate the application credential token based on the first identity verification request; and send the secure deep link and the application credential token to the service provider client. The service provider client is specifically configured to: receive the first identity verification request sent by the service requester, and send the first identity verification request to the service provider server; and receive the secure deep link and the application credential token that are sent by the service provider server, and return the application credential token to the service requester through the secure deep link.

In this embodiment, the service provider server is specifically configured to: receive the application credential token sent by the service provider client; check the application credential token; and if the check succeeds, perform identity verification based on the second identity verification request, and return an identity verification result to the service provider client; otherwise, end a procedure to reject identity verification. The service provider client is specifically configured to: receive the second identity verification request sent by the service requester, and forward the application credential token in the second identity verification request to the service provider server; and receive the identity verification result returned by the service provider server, and return the identity verification result to the service requester.

In this embodiment, the service requester includes a service requester server and a service requester client. The service requester server is specifically configured to: receive an identity verification initialization request generation request sent by the service requester client; generate an identity verification initialization request by using user identity information, and send the identity verification initialization request to the service provider; and receive session_id returned by the service provider, generate the first identity verification request by using session_id, and send the first identity verification request to the service requester client. The service requester client is specifically configured to: generate the identity verification initialization request generation request in response to a user identity authentication request, and send the first identity verification request to the service provider. The service provider is further configured to: after receiving the identity verification initialization request, create a new session, generate session_id related to the session, and cache the identity verification initialization request in the session.

In this embodiment, the service requester client is further configured to: receive an identity verification result returned by the service provider, and send the identity verification result to the service requester server; and receive, from the service requester server, an identity verification result sent for the second time, and grant a corresponding benefit when the identity verification result sent for the second time indicates a success. The service requester server is further configured to: receive the identity verification result sent by the service requester client, send an identity verification result query request to the service provider, where the identity verification result query request includes session_id, receive, from the service provider, the identity verification result sent for the second time, and send, to the service requester client, the identity verification result sent for the second time. The service provider is further configured to: receive the identity verification result query request sent by the service requester server, query the corresponding identity verification result based on session_id, and send the identity verification result for the second time.

In this embodiment, the service provider is specifically configured to generate the application credential token based on merchant identity information in the first identity verification request.

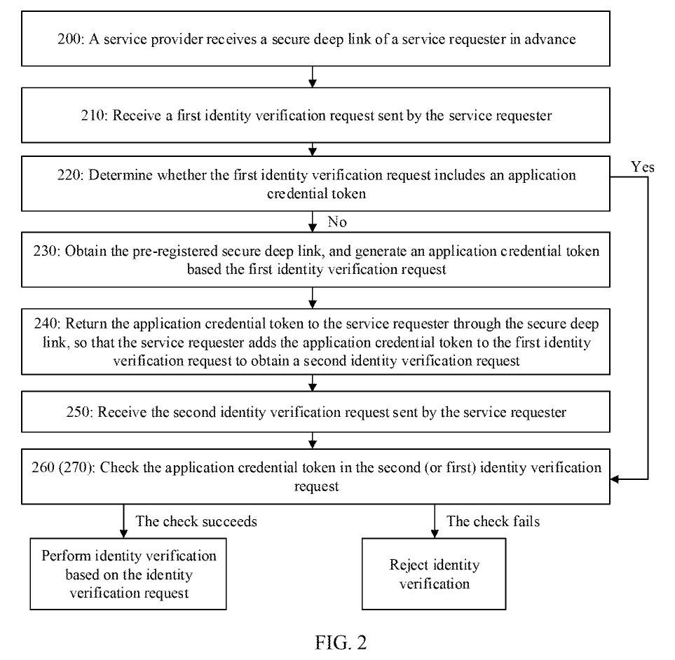

FIG. 2 is a flowchart of a method for implementing a three-party identity verification protocol based on a secure deep link, according to an embodiment. The method also relates to a service requester and a service provider. The service requester includes at least one of a service requester client (that is, a merchant app) on user equipment or a service requester server. The service provider includes at least one of a service provider client (that is, a manufacturer app) on user equipment or a service provider server. The method is applied to the service provider, and includes Steps 200 to 270.

Step 200: The service provider server of the service provider receives a secure deep link of the service requester in advance. Step 200 can specifically include: Step 201 (not shown): The service requester server installs the merchant application on the user equipment, so that the service requester registers with the user equipment to obtain the secure deep link of the service requester. The secure deep link is used to ensure validity and uniqueness of a jump target. In this embodiment, when the user equipment is an Android device, the secure deep link is an app link. When the user equipment is an iOS device, the secure deep link is a universal link. Step 202 (not shown): The service provider server receives the secure deep link that is of the service requester and that is sent by the service requester server. Step 203 (not shown): The service provider server generates a corresponding identifier of the service requester, to complete registration. Step 204 (not shown): The service provider server sends the identifier of the service requester to the service requester server.

Step 200 can be performed only once, and does not need to be performed again in each subsequent transaction.

Step 210: Receive a first identity verification request sent by the service requester. Based on the above-mentioned descriptions, the service requester server has the identifier of the service requester and the corresponding secure deep link of the service requester. Therefore, the first identity verification request includes an identifier on a merchant side.

The service provider client receives the first identity verification request from the service requester, and the service provider server receives the first identity verification request sent by the service provider client.

Step 210 can specifically include: Step 211 (not shown): In response to a user identity authentication request, the service requester generates an identity verification initialization request by using to-be-authenticated user identity information in the user identity authentication request, and sends the identity verification initialization request. Step 212 (not shown). The service requester generates and sends the first identity verification request, where the first identity verification request includes the identifier of the service requester.

Step 220: Determine whether the first identity verification request includes an application credential token. If no application credential token is included, Step 230 is performed. Otherwise, step 270 is performed.

Step 230: Obtain the secure deep link pre-registered by the service requester, and generate an application credential token based on the first identity verification request. Step 230 can specifically include: The service provider server obtains the secure deep link pre-registered by the service requester, and generates the application credential token based on the first identity verification request.

Step 240: Return the application credential token to the service requester through the secure deep link, so that the service requester adds the application credential token to the first identity verification request to obtain a second identity verification request. Step 240 can specifically include: The service provider server sends the secure deep link and the application credential token to the service provider client, so that the service provider client returns the application credential token to the service requester through the secure deep link.

Step 250: Receive the second identity verification request sent by the service requester. Step 260: Check the application credential token carried in the second identity verification request; and if the check succeeds, perform identity verification based on the second identity verification request; otherwise, reject identity verification.

The identity verification request is a face-based identity verification request.

Step 260 can specifically include: Step 261 (not shown): The service provider server receives the application credential token sent by the service provider client. Step 262 (not shown): The service provider server checks the application credential token. Step 263 (not shown): If the check succeeds, the service provider server performs identity verification based on the second identity verification request, and returns an identity verification result to the service provider client, so that the service provider client returns the identity verification result to the service requester, and then ends a procedure; otherwise, the service provider server ends a procedure to reject identity verification.

Step 270: Check the application credential token carried in the first identity verification request; and if the check succeeds, perform identity verification based on the first identity verification request; otherwise, reject identity verification.

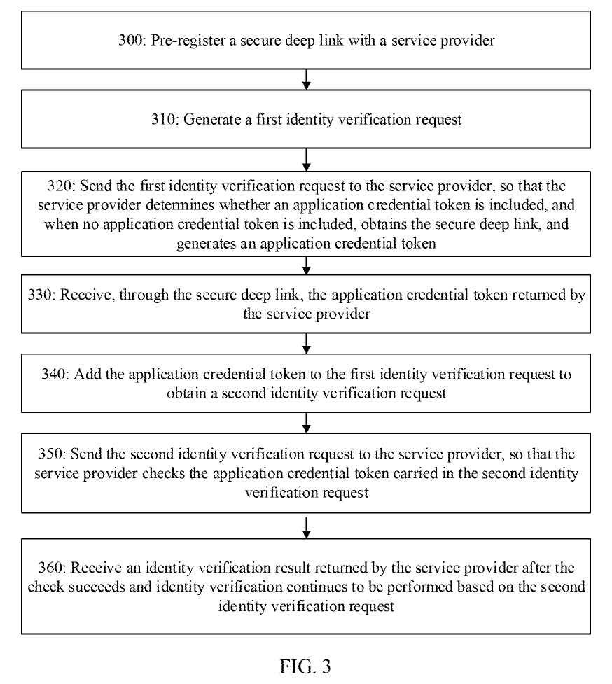

FIG. 3 is a flowchart of a method for implementing a three-party identity verification protocol based on a secure deep link, according to an embodiment. The method also relates to the service requester and a service provider. The service requester includes at least one of a service requester client (that is, a merchant app) on user equipment or a service requester server. The service provider includes at least one of a service provider client (that is, a manufacturer app) on user equipment or a service provider server. The method is applied to a service requester, and includes steps 300 to 360.

Step 300: Pre-register a secure deep link with the service provider.

The secure deep link is used to ensure validity and uniqueness of a jump target. In this embodiment, when the user equipment is an Android device, the secure deep link is an app link. When the user equipment is an iOS device, the secure deep link is a universal link.

Step 300 can specifically include: Step 301 (not shown): The service requester server installs the service requester client on the user equipment, to register with the user equipment to obtain a secure deep link on a merchant side. Step 302 (not shown): The service requester server sends the secure deep link of the service requester to the service provider, so that the service provider generates an identifier of the service requester, to complete registration. Step 303 (not shown): The service requester server receives the identifier that is of the service requester and that is sent by the service provider.

Step 310: Generate a first identity verification request, where the first identity verification request includes the identifier of the service requester.

Step 310 can specifically include: Step 311 (not shown): The service requester server receives an identity verification initialization request generation request sent by the service requester client, where the identity verification initialization request generation request is generated by the service requester client in response to a user identity authentication request. Step 312 (not shown): The service requester server generates an identity verification initialization request by using user identity information, and sends the identity verification initialization request to the service provider, so that the service provider creates a new session, generates session_id related to the session, and caches the identity verification initialization request in the session. Step 313 (not shown): Receive session_id returned by the service provider, generate the first identity verification request by using session_id, and send the first identity verification request to the service requester client, so that the service requester client sends the first identity verification request to the service provider.

Step 320: Send the first identity verification request to the service provider, so that the service provider determines whether the first identity verification request includes an application credential token, and when no application credential token is included, obtains the secure deep link pre-registered by the service requester, and generates an application credential token based on the first identity verification request. The application credential token is generated by the service provider server based on merchant identity information in the first identity verification request.

Step 330: Receive, through the secure deep link, the application credential token returned by the service provider. After the receiving the application credential token returned by the service provider, the method can further include: locally storing the application credential token.

Step 340: Add the application credential token to the first identity verification request to obtain a second identity verification request.

Step 350: Send the second identity verification request to the service provider, so that the service provider checks the application credential token carried in the second identity verification request.

Step 360: Receive an identity verification result returned by the service provider after the check succeeds and identity verification continues to be performed based on the second identity verification request.

After the receiving an identity verification result returned by the service provider, the method can further include: Step 371 (not shown): Determine whether the service requester stores a valid application credential token, and if yes, generate another first identity verification request that carries the application credential token. Step 372 (not shown): Repeat the step of sending the first identity verification request to the service provider, so that the service provider determines whether the first identity verification request includes an application credential token, and when the first identity verification request includes an application credential token, checks the application credential token carried in the first identity verification request. Step 373 (not shown): Receive an identity verification result returned by the service provider after the check succeeds and identity verification continues to be performed based on the first identity verification request.

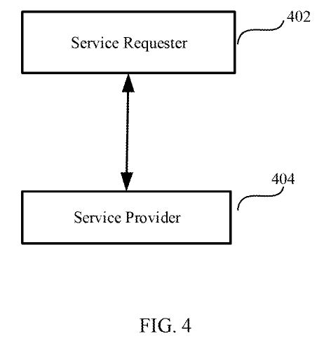

FIG. 4 is a schematic diagram of a system for implementing a three-party identity verification protocol based on a secure deep link, according to an embodiment. The system includes a service requester 402 and a service provider 404. The service requester 402 includes at least one of a service requester client (e.g., a merchant app) on user equipment or a service requester server. The service provider 404 includes at least one of a service provider client (e.g., a manufacturer app) on user equipment or a service provider server. The service requester client and the service provider client can be located on the same user equipment, and the user equipment can be an Android or iOS device. The system is configured to perform the above described method for implementing a three-party identity verification protocol based on a secure deep link.

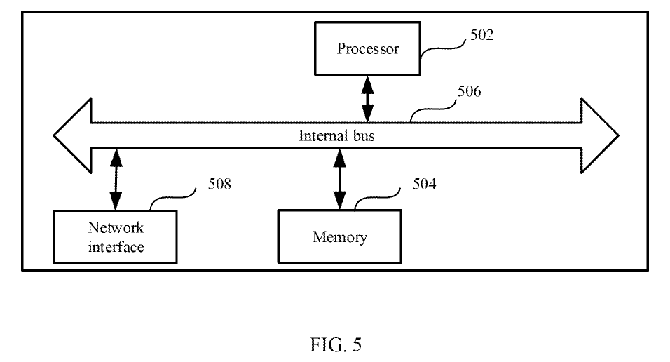

FIG. 5 is a schematic diagram of a computing device for implementing a three-party identity verification protocol based on a secure deep link, according to an embodiment. For example, the device may be any of the user equipment, the service requester server, or the service provider server described above. The device includes a processor 502 and a memory 504 storing instructions executable by the processor 502, and may also include an internal bus 506, a network interface 508, or other needed hardware. The processor 502 is configured to perform the above described method for implementing a three-party identity verification protocol based on a secure deep link.

Embodiments of the present disclosure provide a system and a method for implementing a three-party identity verification protocol based on a secure deep link, to help a service provider obtain information about an external service requester without depending on a system interface.

According to a first aspect of the present disclosure, a system for implementing a three-party identity verification protocol based on a secure deep link, includes: a service requester and a service provider. The service requester generates a first identity verification request; sends the first identity verification request to the service provider; when an application credential token is received through a secure deep link, adds the application credential token to the first identity verification request to obtain a second identity verification request; and sends the second identity verification request to the service provider. The service provider receives the first identity verification request sent by the service requester; determines whether the first identity verification request includes an application credential token; and if no application credential token is included, obtains a secure deep link pre-registered by the service requester, and generates an application credential token based on the first identity verification request; returns the application credential token to the service requester through the secure deep link; receives the second identity verification request sent by the service requester, and checks the application credential token carried in the second identity verification request; and if the check succeeds, performs identity verification based on the second identity verification request; otherwise, rejects identity verification.

In an embodiment, after the application credential token is received through the secure deep link, the service requester is further configured to locally store the application credential token. The service provider is further configured to: if the first identity verification request includes an application credential token, check the application credential token carried in the first identity verification request; and if the check succeeds, perform identity verification based on the first identity verification request; otherwise, reject identity verification.

In an embodiment, the service requester is specifically configured to: determine whether the service requester stores a valid application credential token, and if yes, generate a first identity verification request that carries the application credential token; otherwise, generate a first identity verification request that carries no application credential token.

In an embodiment, the secure deep link is an app link or a universal link. Before generating the identity verification request, the service requester is further configured to: register to obtain the secure deep link of the service requester; send the secure deep link of the service requester to the service provider; and receive an identifier that is of the service requester and that is sent by the service provider. Before receiving the identity verification request sent by the service requester, the service provider is further configured to: receive the secure deep link obtained by the service requester through registration; generate the identifier of the service requester, to complete pre-registration of the secure deep link; and send the identifier of the service requester to the service requester. The first identity verification request includes the identifier of the service requester.

In an embodiment, the service provider includes a service provider server and a service provider client. The service provider server is specifically configured to: receive the first identity verification request sent by the service provider client; obtain the secure deep link pre-registered by the service requester, and generate the application credential token based on the first identity verification request; and send the secure deep link and the application credential token to the service provider client. The service provider client is specifically configured to: receive the first identity verification request sent by the service requester, and send the first identity verification request to the service provider server; and receive the secure deep link and the application credential token that are sent by the service provider server, and return the application credential token to the service requester through the secure deep link.

In an embodiment, the service provider server is specifically configured to: receive the application credential token sent by the service provider client; check the application credential token; and if the check succeeds, perform identity verification based on the second identity verification request, and return an identity verification result to the service provider client; otherwise, end a procedure to reject identity verification. The service provider client is specifically configured to: receive the second identity verification request sent by the service requester, and forward the application credential token in the second identity verification request to the service provider server; and receive the identity verification result returned by the service provider server, and return the identity verification result to the service requester.

In an embodiment, the service requester includes a service requester server and a service requester client. The service requester server is specifically configured to: receive an identity verification initialization request generation request sent by the service requester client; generate an identity verification initialization request by using user identity information, and send the identity verification initialization request to the service provider; and receive session_id returned by the service provider, generate the first identity verification request by using session_id, and send the first identity verification request to the service requester client. The service requester client is specifically configured to: generate the identity verification initialization request generation request in response to a user identity authentication request, and send the first identity verification request to the service provider. The service provider is further configured to: after receiving the identity verification initialization request, create a new session, generate session_id related to the session, and cache the identity verification initialization request in the session.

In an embodiment, the service requester client is further configured to: receive an identity verification result returned by the service provider, and send the identity verification result to the service requester server; and receive, from the service requester server, an identity verification result sent for the second time, and grant a corresponding benefit when the identity verification result sent for the second time indicates a success. The service requester server is further configured to: receive the identity verification result sent by the service requester client, send an identity verification result query request to the service provider, where the identity verification result query request includes session_id, receive, from the service provider, the identity verification result sent for the second time, and send the identity verification result from the service provider to the service requester client. The service provider is further configured to: receive the identity verification result query request sent by the service requester server, query the corresponding identity verification result based on session_id, and send the identity verification result for the second time.

In an embodiment, the service provider is specifically configured to generate the application credential token based on merchant identity information in the first identity verification request.

In an embodiment, the first identity verification request and the second identity verification request are face-based identity verification requests. The service provider is specifically configured to: receive a face input by a user, compare the face input by the user with user identity information corresponding to the face-based identity verification request, and obtain an identity information result based on a comparison result.

According to a second aspect of the present disclosure, a method for implementing a three-party identity verification protocol based on a secure deep link is applied to a service provider, and includes: receiving a first identity verification request sent by a service requester, where the first identity verification request is generated by the service requester; determining whether the first identity verification request includes an application credential token; and if no application credential token is included, obtaining a secure deep link pre-registered by the service requester, and generating an application credential token based on the first identity verification request; returning the application credential token to the service requester through the secure deep link, so that the service requester adds the application credential token to the first identity verification request to obtain a second identity verification request; receiving the second identity verification request sent by the service requester; checking the application credential token carried in the second identity verification request; and if the check succeeds, performing identity verification based on the second identity verification request; otherwise, rejecting identity verification.

In an embodiment, if the first identity verification request includes an application credential token, the application credential token carried in the first identity verification request is checked; and if the check succeeds, identity verification is performed based on the first identity verification request; otherwise, identity verification is rejected.

In an embodiment, the secure deep link is an app link or a universal link. Before the receiving an identity verification request sent by a service requester, the method further includes: The service provider receives the secure deep link obtained by the service requester through registration; and the service provider generates an identifier of the service requester, to complete pre-registration of the secure deep link; and sends the identifier of the service requester to the service requester. The first identity verification request includes the identifier of the service requester.

In an embodiment, the service provider includes a service provider server and a service provider client. The determining whether the first identity verification request includes an application credential token; and if no application credential token is included, obtaining a secure deep link pre-registered by the service requester specifically includes: The service provider server receives the first identity verification request sent by the service provider client; the service provider server obtains the secure deep link pre-registered by the service requester, and generates the application credential token based on the first identity verification request; and the service provider server sends the secure deep link and the application credential token to the service provider client, so that the service provider client returns the application credential token to the service requester through the secure deep link.

In an embodiment, the checking the application credential token carried in the second identity verification request; and if the check succeeds, performing identity verification based on the second identity verification request; otherwise, rejecting identity verification specifically includes: A service provider server receives the application credential token sent by a service provider client; the service provider server checks the application credential token; and if the check succeeds, the service provider server performs identity verification based on the second identity verification request, and returns an identity verification result to the service provider client, so that the service provider client returns the identity verification result to the service requester; otherwise, the service provider server ends a procedure to reject identity verification.

According to a third aspect of the present disclosure, a method for implementing a three-party identity verification protocol based on a secure deep link is applied to a service requester, and includes: generating a first identity verification request; sending the first identity verification request to a service provider, so that the service provider determines whether the first identity verification request includes an application credential token, and when no application credential token is included, obtains a secure deep link pre-registered by the service requester, and generates an application credential token based on the first identity verification request; receiving, through the secure deep link, the application credential token returned by the service provider; adding the application credential token to the first identity verification request to obtain a second identity verification request; sending the second identity verification request to the service provider, so that the service provider checks the application credential token carried in the second identity verification request; and receiving an identity verification result returned by the service provider after the check succeeds and identity verification continues to be performed based on the second identity verification request.

In an embodiment, after the receiving, through the secure deep link, the application credential token returned by the service provider, the method further includes: locally storing the application credential token. In addition, after the receiving an identity verification result returned by the service provider, the method further includes: determining whether the service requester stores a valid application credential token, and if yes, generating another first identity verification request that carries the application credential token; repeating the step of sending the first identity verification request to a service provider, so that the service provider determines whether the first identity verification request includes an application credential token, and when the first identity verification request includes an application credential token, checks the application credential token carried in the first identity verification request; and receiving an identity verification result returned by the service provider after the check succeeds and identity verification continues to be performed based on the first identity verification request.

In an embodiment, the secure deep link is an app link or a universal link. Before the generating an identity verification request, the method further includes: registering to obtain the secure deep link of the service requester; sending the secure deep link of the service requester to the service provider, so that the service provider generates an identifier of the service requester, to complete pre-registration of the secure deep link; and receiving the identifier that is of the service requester and that is sent by the service provider. In addition, the first identity verification request includes the identifier of the service requester.

According to another aspect of the present disclosure, a non-transitory computer-readable storage medium stores a computer program, and when the computer program is executed by a processor, the processor is caused to perform the above method according to the first, second, or third aspect.

According to another aspect, the present disclosure, a computing device includes a processor and a memory storing instructions executable by the processor. The processor is configured to perform the above method according to the first, second, or third aspect.

The system for implementing a three-party identity verification protocol according to the present disclosure customizes an interaction procedure between a service requester and a service provider through a native secure deep link of iOS or Android, to help the service provider for identity authentication correctly obtain identity information of the service requester to correctly identify an identity of a service requester client, and resolve a problem that the service provider for identity authentication cannot identify an identity of the external service requester, thereby supporting necessary security detection. The newly added interaction procedure can be implemented through a client SDK provided by a platform. Therefore, access and modification costs for the service requester are relatively low. In addition, an interaction process of obtaining an application credential token needs to be performed only once, and subsequent face-based identity verification can be performed by using the previously obtained application credential token. Therefore, overall performance loss of the system is relatively small.

The above descriptions are merely example embodiments of the present disclosure, and are not intended to limit the scope of the present disclosure. Various changes can be further made to the above embodiments. Any simple, equivalent changes and modifications made based on the content of this specification shall fall within the protection scope of the claims.

1. A system for implementing a three-party identity verification protocol based on a secure deep link, comprising:
a service requester; and
a service provider,
wherein:
the service requester generates a first identity verification request; sends the first identity verification request to the service provider; when an application credential token is received through a secure deep link, adds the application credential token to the first identity verification request to obtain a second identity verification request; and sends the second identity verification request to the service provider; and
the service provider receives the first identity verification request sent by the service requester; determines whether the first identity verification request comprises an application credential token; and if no application credential token is comprised, obtains a secure deep link pre-registered by the service requester, and generates an application credential token based on the first identity verification request; returns the application credential token to the service requester through the secure deep link; receives the second identity verification request sent by the service requester, and checks the application credential token carried in the second identity verification request; and if the check succeeds, performs identity verification based on the second identity verification request; otherwise, rejects identity verification.

2. The system according to claim 1, wherein after the application credential token is received through the secure deep link, the service requester is further configured to locally store the application credential token; and
the service provider is further configured to: if the first identity verification request comprises an application credential token, check the application credential token carried in the first identity verification request; and if the check succeeds, perform identity verification based on the first identity verification request; otherwise, reject identity verification.

3. The system according to claim 1, wherein the service requester is further configured to: determine whether the service requester stores a valid application credential token, and if yes, generate the first identity verification request that carries the application credential token; otherwise, generate the first identity verification request that carries no application credential token.

4. The system according to claim 1, wherein the secure deep link is an app link or a universal link;
before generating the identity verification request, the service requester is further configured to: register to obtain the secure deep link of the service requester; send the secure deep link of the service requester to the service provider; and receive an identifier of the service requester that is sent by the service provider;
before receiving the identity verification request sent by the service requester, the service provider is further configured to: receive the secure deep link obtained by the service requester through registration; generate the identifier of the service requester, to complete pre-registration of the secure deep link; and send the identifier of the service requester to the service requester;
the first identity verification request comprises the identifier of the service requester; and
the service provider is further configured to obtain, based on the identifier of the service requester, the secure deep link pre-registered by the service requester.

5. The system according to claim 1, wherein the service provider comprises a service provider server and a service provider client;
the service provider server is configured to: receive the first identity verification request sent by the service provider client; obtain the secure deep link pre-registered by the service requester, and generate the application credential token based on the first identity verification request; and send the secure deep link and the application credential token to the service provider client; and
the service provider client is configured to: receive the first identity verification request sent by the service requester, and send the first identity verification request to the service provider server; and receive the secure deep link and the application credential token that are sent by the service provider server, and return the application credential token to the service requester through the secure deep link.

6. The system according to claim 5, wherein the service provider server is further configured to: receive the application credential token sent by the service provider client; check the application credential token; and if the check succeeds, perform identity verification based on the second identity verification request, and return, to the service provider client, an identity verification result sent for the second time; otherwise, end a procedure to reject identity verification; and
the service provider client is further configured to: receive the second identity verification request sent by the service requester, and forward the application credential token in the second identity verification request to the service provider server; and receive, from the service provider server, the identity verification result sent for the second time, and return, to the service requester, the identity verification result sent for the second time.

7. The system according to claim 1, wherein the service requester comprises a service requester server and a service requester client;
the service requester server is configured to: receive an identity verification initialization request generation request sent by the service requester client; generate an identity verification initialization request by using user identity information, and send the identity verification initialization request to the service provider; and receive a session ID returned by the service provider, generate the first identity verification request by using the session ID, and send the first identity verification request to the service requester client;
the service requester client is configured to: generate the identity verification initialization request generation request in response to a user identity authentication request, and send the first identity verification request to the service provider; and
the service provider is further configured to: after receiving the identity verification initialization request, create a new session, generate the session ID related to the session, and cache the identity verification initialization request in the session.

8. The system according to claim 7, wherein the service requester client is further configured to: receive an identity verification result returned by the service provider, and send the identity verification result to the service requester server; and receive, from the service requester server, an identity verification result sent for the second time, and grant a corresponding benefit when the identity verification result sent for the second time indicates a success;
the service requester server is further configured to: receive the identity verification result sent by the service requester client, send an identity verification result query request to the service provider, wherein the identity verification result query request comprises the session ID, receive, from the service provider, the identity verification result sent for the second time, and send, to the service requester client, the identity verification result sent for the second time; and
the service provider is further configured to: receive the identity verification result query request sent by the service requester server, query the corresponding identity verification result based on the session ID, and send the identity verification result for the second time.

9. The system according to claim 1, wherein the service provider is further configured to generate the application credential token based on merchant identity information in the first identity verification request.

10. The system according to claim 1, wherein the first identity verification request and the second identity verification request are face-based identity verification requests; and
the service provider is further configured to: receive a face input by a user, compare the face input by the user with user identity information corresponding to the face-based identity verification request, and obtain an identity information result based on a comparison result.

11. A method for implementing a three-party identity verification protocol based on a secure deep link, applied to a service provider, and comprising:
receiving a first identity verification request sent by a service requester, wherein the first identity verification request is generated by the service requester;
determining whether the first identity verification request comprises an application credential token; and
if no application credential token is comprised:
obtaining a secure deep link pre-registered by the service requester, and generating an application credential token based on the first identity verification request;
returning the application credential token to the service requester through the secure deep link, so that the service requester adds the application credential token to the first identity verification request to obtain a second identity verification request;
receiving the second identity verification request sent by the service requester;
checking the application credential token carried in the second identity verification request; and
if the check succeeds, performing identity verification based on the second identity verification request; otherwise, rejecting identity verification.

12. The method according to claim 11, wherein if the first identity verification request comprises an application credential token:
the application credential token carried in the first identity verification request is checked; and
if the check succeeds, identity verification is performed based on the first identity verification request; otherwise, identity verification is rejected.

13. The method according to claim 11, wherein the secure deep link is an app link or a universal link;
before the receiving the identity verification request sent by the service requester, the method further comprises:
receiving, by the service provider, the secure deep link obtained by the service requester through registration;
generating, by the service provider, an identifier of the service requester, to complete pre-registration of the secure deep link; and
sending the identifier of the service requester to the service requester;
the first identity verification request comprises the identifier of the service requester; and
the obtaining the secure deep link pre-registered by the service requester comprises: obtaining, based on the identifier of the service requester, the secure deep link pre-registered by the service requester.

14. The method according to claim 11, wherein the service provider comprises a service provider server and a service provider client; and
the method further comprises:
receiving, by the service provider server, the first identity verification request sent by the service provider client;
obtaining, by the service provider server, the secure deep link pre-registered by the service requester, and generating the application credential token based on the first identity verification request; and
sending, by the service provider server, the secure deep link and the application credential token to the service provider client, so that the service provider client returns the application credential token to the service requester through the secure deep link.

15. The method according to claim 11, further comprising:
receiving, by a service provider server, the application credential token sent by a service provider client;
checking, by the service provider server, the application credential token; and
if the check succeeds, performing, by the service provider server, identity verification based on the second identity verification request, and returning an identity verification result to the service provider client, so that the service provider client returns the identity verification result to the service requester; otherwise, ending, by the service provider server, a procedure to reject identity verification.

16. A method for implementing a three-party identity verification protocol based on a secure deep link, applied to a service requester, and comprising:
generating a first identity verification request;
sending the first identity verification request to a service provider, so that the service provider determines whether the first identity verification request comprises an application credential token, and when no application credential token is comprised, obtains a secure deep link pre-registered by the service requester, and generates an application credential token based on the first identity verification request;
receiving, through the secure deep link, the application credential token returned by the service provider;
adding the application credential token to the first identity verification request to obtain a second identity verification request;
sending the second identity verification request to the service provider, so that the service provider checks the application credential token carried in the second identity verification request; and
receiving an identity verification result returned by the service provider after the check succeeds and identity verification continues to be performed based on the second identity verification request.

17. The method according to claim 16, wherein after the receiving, through the secure deep link, the application credential token returned by the service provider, the method further comprises: locally storing the application credential token; and
after the receiving the identity verification result returned by the service provider, the method further comprises:
determining whether the service requester stores a valid application credential token, and if yes, generating another first identity verification request that carries the application credential token;
repeating the sending the first identity verification request to the service provider, so that the service provider determines whether the first identity verification request comprises an application credential token, and when the first identity verification request comprises an application credential token, checks the application credential token carried in the first identity verification request; and
receiving an identity verification result returned by the service provider after the check succeeds and identity verification continues to be performed based on the first identity verification request.

18. The method according to claim 16, wherein the secure deep link is an app link or a universal link;
before the generating the identity verification request, the method further comprises:
registering to obtain the secure deep link of the service requester;
sending the secure deep link of the service requester to the service provider, so that the service provider generates an identifier of the service requester, to complete pre-registration of the secure deep link; and
receiving the identifier that is of the service requester and that is sent by the service provider;
the first identity verification request comprises the identifier of the service requester; and
the obtaining the secure deep link pre-registered by the service requester further comprises: obtaining, based on the identifier of the service requester, the secure deep link pre-registered by the service requester.

19. A non-transitory computer-readable storage medium storing a computer program that, when executed by a processor, causes the processor to perform the method according to claim 11.

20. A computing device, comprising:
a processor; and
a memory storing instructions executable by the processor,
wherein the processor is configured to perform the method according to claim 11.
